(19) United States
(12) Patent Application Publication
(10) Pub. No.: US 2010/0050377 A1
(43) Pub. Date: Mar. 4, 2010

(54) Door Mounted Finger Safety Device and Its Method of Use

(76) Inventor: Roman Ritachka, Weaverville, CA (US)

Correspondence Address: Office of Donald Grant Kelly, POB 320056, ALEXANDRIA, VA, 22320, US

(21) Appl. No.: 12/585,059

(22) Filed: Sep. 2, 2009

Related U.S. Application Data
(60) Provisional application No. 61/136,404, filed on Sep. 3, 2008.

(51) Int. Cl. E05F 5/02; E05F 5/06

(52) U.S. Cl. 16/83; 16/85

(57) ABSTRACT

A door check device to be mounted to a door for selectively maintaining a gap when door closing is attempted. This prevents injuries to children's fingers and the like. The door check includes a base with a journal having action arm pivoted at its proximal end. The arm has a distal end extending outwardly to engage a doorstop. Indexing sockets are formed along the arm's proximal end. Each socket collaborates with the nose of a spring-biased detent to retain the action arm in a preselected position. The arm may be set in a first position to directly engage the doorstop to form a gap. Set in a second position the arm allows door closing but, upon next opening, the arm automatically reverts to door checking position. In a third position the arm is fully lowered to disable the check device. This device may find application to a variety of closures.

### REFERENCE TO RELATED APPLICATIONS

This application is entitled to the benefit of provisional patent application Ser. No. 61/136,404 filed Sep. 3, 2008; such benefit is hereby claimed under 35 USC 119(e) and the content of said application in its entirety and for all purposes is incorporated herein by reference.

### STATEMENT REGARDING FEDERALLY SPONSORED RESEARCH OR DEVELOPMENT

Not applicable

### REFERENCE TO SEQUENCE LISTING

Not applicable

### BACKGROUND OF THE INVENTION

1. Field of the Invention

The invention disclosed herein generally relates to the field of door hardware and more specifically to mechanisms for preventing a door or equivalent closure from fully closing by mechanically maintaining at least a small gap along each lateral edge, thereby keeping the door slightly ajar. Described herein are a unique gap-retaining mechanism and its method of use.

Each year, tens of thousands of children in the United States receive serious injuries when closures accidentally engage their fingers. Sadly, an alarming number of these result in at least partial amputation. Described herein are a device and method of using the unique device embodying novel and non-obvious advancements to address this growing problem.

2. Description of Related Art

Various alternatives currently exist for maintaining a door or similar closures slightly open or ajar. Over the years a number of names for such anti-closure devices and their assigned functions with respect to doors, gates, windows, drawers and the like have entered the common lexicon. For example, a device for maintaining an open gap might be variously referred to as a check, stop, brace, spacer, hook, prop or simply a “hold-open”. These devices have been developed with a variety of objectives, among these are: avoiding unexpected closure injury to a small child or pet; keeping a closure from unwanted latching or locking; maintaining a closure in open or unlatched state for temporary periods for ventilation, passage or observation; maintaining a door or window to a baby's nursery or other important space slightly ajar for monitoring purposes. For simplicity and without intention to delimit the present invention, these and similarly purposed devices are herein referred to as door checks.

Over the years many door checks have been invented and commercialized for purposes such as just described, and many of those inventions have been patented. Examples of patent documents addressing the need for keeping a door ajar include the following. U.S. Pat. No. 6,550,828 to Warden shows door gap retention by way of clamps and inserted panels. U.S. Pat. No. 1,258,856 to Beaudette depicts a nursery door check that slows the door swing and subsequently permits closure with added pressure. U.S. Pat. No. 2,565,906 to Berthane demonstrates a device for retaining doors ajar. The Berthane device features a yoke configured to fit over the top of a door and a bumper that extends therefrom to engage the door's sill.

Comaianni's U.S. Pat. No. D346109 illustrates a door spacer mechanism attached to a door frame and appears to present an arm in two positions: a first position where the arm is extending above a door; a second position where the arm extends downwardly apparently to check a door. Ferrante's U.S. Pat. No. 3,287,050 discloses an adjustable brace fixed to a door jamb and engaging a door edge to maintain the door in fully open position. Ferrante's brace swings clear to permit closure. U.S. Pat. No. 4,982,474 granted to Kjellstrom prevents door crushing injuries by providing a check device in the form of a spring biased blocking component attached to a door and articulated to engage the door case to prevent the door's closure.

U.S. Pat. No. 6,510,587 to Urschel et al. describes a device for temporarily preventing a door closure upon its first opening; but, upon the door's reopening, the device permits closure. This device is fairly complex in its number of parts. U.S. Pat. No. 900,621 to Voight shows a mechanism mounted on the upper portion of a door casing and extending to engage the top of a swinging door. Voight's invention is for holding the door slightly ajar to indicate that a room currently is unoccupied. To disengage the mechanism so that passage is permitted, the door is further opened for passage and then may be fully closed. The Voight arrangement is for indicating room availability and without regard to safety, ventilation and the like.

Weinberger's U.S. Pat. No. 3,620,483 includes a door holding yoke that extends to, and embraces, a portion of the door frame or directly interconnecting to a frame-mounted rail with an engagement bead. U.S. Pat. No. D347,570 was issued to Burge for a resilient door stop element that fits about a door edge to prevent door movement. Donovan's U.S. Pat. No. 5,123,685 discloses a sliding leg mounted on a door and arranged to abut a door jamb to keep the door ajar. McLean's U.S. Pat. No. 4,261,140 Features a checking element that falls into door-blocking position when the door is opened.

The record will show that each of the aforementioned patent documents in its entirety was incorporated by reference in the above noted Provisional Patent Application. Upon close review of the patents discussed hereabove, it is apparent that they address similar objectives, but do so through a variety of mechanical constructs substantially different from the present invention. Moreover, none offers the unique configuration and distinct functional advantages afforded by the present invention described and claimed as follows.

### BRIEF SUMMARY OF THE INVENTION

The present invention has a principal focus on safety, and is presented as a device designed and configured particularly to prevent accidental injuries to children and pets, though not limited thereto. For example, the described device would be mounted on the closing face of a door. Again, it is important to understand that the term “door” is not intended to limit the invention as to its sole environment of application. Indeed, the invention may have application with respect to closures in any of a variety of applications including, for example: room doorways and entranceways; patio windows/doors; bathroom shower doors, garage side entrances and so forth. Moreover, the present invention may be configured to apply to cabinet doors or drawers, trunk lids, and equivalents thereof. For simplicity and brevity, however, the present invention will be described in the context of a door and doorway environment.

In typical carpentry jargon, the term “doorstop” is commonly applied to the strip of molding, ranging in width from one inch to several inches. The doorstop usually is recessed or set back from the door frame facing by a distance roughly equal to the door thickness and provides a limiting position for door closure (hence the term “stop”). Major objectives served by the doorstop are both functional and aesthetic: to prevent a closing door from “swinging through” the doorway casing, and to support the door such that its visible surface is on a plane consistently level with the door frame facing. The doorstop strip typically borders the door jamb and also hides the gap between the door and the jamb. For more information in this respect, readers' attention is directed to the Internet world wide web (www) address for metaglossary.com/meanings/855932. Typically, the open right angle formed at the joiner of strips of wood (for example, between the door stop and jamb, is known by the woodworking expression “reveal.” These structural relationships often appear in other closures, as well, for example: trunks, windows and the like.

The phrase “closing face” as used herein to reference the substantially flat, major surface of a door, bound by its four associated edges. More specifically, the closing face is the door surface that swings within the door casing toward a door frame, jamb and doorstop as the door is “closed.” When fully closed, the door generally engages within the doorstop “reveal” where its swinging motion is arrested. The door typically engages the doorstop at its reveal along the door's top edge and two lateral (generally vertical surface) edges, respectively at its latch and hinge sides. The bottommost, generally horizontal door surface/edge may, or may not, face an abutting threshold doorstop. The inventive door check to be more fully described below is configured to engage the doorstop, and it is equally effective in preventing injuries at all such edges. The typical application of the inventive door check is at the topmost door edge, though the invention should not be considered so limited.

The inventive door check device includes an action arm pivotally attached at its proximal end to a base member. The door check base member is configured to be suitably mounted on the door's closing face. The base member may be configured to be mounted to the door through an intermediate wedge or shim element. This results in an angular orientation of the door check action arm relative to the door surface. As the door and the angularly extended action arm are swung toward the doorstop, the door check's angular orientation relative to the closing face of the door results in a substantially normal (right angle) approach to the doorstop. This substantially normal approach minimizes lateral or bending forces on the arm, thus commanding a less robust arm construction. It also lessens scuffing damage to the doorstop.

The proximal end of said action arm terminates in an arcuate portion pivoted about an axis pin within a journal structure on the base. The journal structure may be either affixed to, or integral with, the door check base. The action arm extends from its journalled location outwardly to a distal end configured to engage the doorstop. The action arm arcuate portion is configured to turn about its journal pivot so as to place the arm in each of (at least) three different modes or positions. For example, the action arm may swing upwardly to a position slightly above horizontal—herein described as the action arm's “door check position.” Alternatively, the action arm may be swung downwardly somewhat below horizontal to a midway position—herein described as the action arm's “trigger re-set position.” Upon further swinging movement about the pivot axis, the action arm may retreat fully downwardly to its “disabled position” where it essentially is out of service.

When in its “trigger re-set position,” an uppermost corner portion of the action arm proximal end protrudes or juts slightly above the base journal so as to be exposed at an upper extreme of the door check device. This “protruding corner” configuration is key to the functionality of the inventive door check device. The action arm may be set in each of the above-mentioned (at least) three positions by a keeper mechanism comprising a resilient detent (spring-biased ball) configured to engage with indexing sockets or depressions defined along the surface of said arcuate portion.

For example, with the resilient detent engaged in the defined socket or depression closest to the action arm's very proximal end, the action arm is set in its door checking position. The next defined depression formed along the action arm cooperates with the resilient detent to set the door check device in its trigger re-set mode. Next after that is the defined depression for optionally setting the action arm in a disabled mode. These settings are temporary conditions or modes achieved either by hand or by force of door check/doorstop interaction, to be explained.

The inventive door check device is affixed to the door's closing face, substantially at the door's uppermost edge. Reasonably precise door check device placement is important. This enables the entire door check device (in its trigger re-set mode) to glide beneath the doorstop as the closing face of the door engages the doorstop. As it traverses beneath the doorstop, the uppermost corner of the proximal end of the action arm interferes with the doorstop and tends to force the proximal end downward and, correspondingly, its distal end upwardly. As the arm tilts slightly upwardly (due to engagement of the jutting corner with the doorstop), the resilient detent automatically re-sets the arm to door checking mode. When the door is subsequently opened, the action arm immediately snaps upwardly, ready to check the door when its next closing is attempted.

In another example, when the door check device is set in its disabled mode, the resultant arm position is tilted fully downwardly so far that the door check device glides beneath the doorstop without any interaction therewith. This is because, in the disabled mode, the very proximal end of the action arm just beyond its pivot axis is essentially flat (or even) with its associated journal. In this configuration there is no upwardly projecting corner of the action arm proximal end. As long as the door check device is in disabled mode, no door checking takes place, no re-set action takes place, and no protection is afforded against injury. In this mode, it is as if the door check device is not present.

Whether, or not, the arm engages the doorstop depends on its action mode setting as governed by the positional engagement of the biased detent ball in a defined socket or depression. For users with sufficient reach, mode settings may be changed by manually raising or lowering the arm's distal end. To accommodate other users where appropriate, a chain, cord or rod implement may be suitably attached.

Thus, the safety device, in its operative or activated position, prevents full closure of the door leaving a gap at the door's edges which is intended to be at least a predetermined width. Depending upon the intended use of the inventive device, the resultant gap achieved (wider or narrower) can be predetermined or preset by the device's initial placement and configuration. The gap, for example, may be selected at about the thickness of a child's largest finger or the width of a pet's tail.

While not intended as limiting this invention, an example of a minimal gap between the door and its normally closed position might be in the range of ⅜ inch—generally enough to prevent serious bone injury. This gap may be achieved where the inventive device is mounted near the upper edge of a typical door and spaced about 6 inches from its hinged edge.

This gap may be more or less extensive as determined by the location of the device attachment along the top edge of the door, and of course by the length of the action arm. For example, positioning the door check device closer to the door's hinge edge may require a shorter articulated arm. Positioning the device a greater distance from the door's hinge edge will, of course, change the parameters proportionally.

It must be kept in mind that the objective is to afford a relatively narrow gap at the door closure edges, including the hinge-gap located at the door edge opposite the doorknob/latch area. It bears repeating that the gap should be no narrower than a human's finger or other appendages or perhaps the tail, paw or nose of a pet. Gap choices for ventilation, pet passage and such may of course be considerably wider.

While this description is primarily focused on a child's safety, it will be apparent that the present device may enjoy other applications such as keeping a child from locking himself/herself in a room. As noted, still other uses may include: maintaining a ventilating air flow passage around a door while purposely held slightly ajar. Another application would be to prevent a wind gust from fully closing an open door. A storage trunk may be propped open with this inventive check device in order to aerate its contents. With many storage trunks having metal edges along the closing portions, the present invention can protect against injury. Thus, the invention herein described and claimed as having novel configuration and function should not be considered limited to any specific problem solution.

### BRIEF DESCRIPTION OF THE DRAWINGS

The present invention will be best understood by reference to the following detailed description of an illustrative embodiment when read in conjunction with the accompanying drawings, wherein:

FIG. 1 shows a perspective view of the front side of the device with articulated action arm in slightly lowered position, or trigger re-set mode;

FIG. 2 is a perspective view of the device partially disassembled and with the action arm disconnected to reveal important mode setting details;

FIG. 3 is a front perspective of the device with the action arm in door checking mode;

FIG. 4 is a backside perspective view of the device with the action arm partially lowered to its trigger re-set mode;

FIG. 5 is a backside perspective similar to FIG. 4, with the action arm placed in its inactivated, fully lowered position;

FIG. 6 is a backside perspective similar to FIG. 4, again showing the action arm in trigger re-set mode;

FIG. 7 is a backside perspective similar to FIGS. 5 and 6, with the action arm raised in door checking mode;

FIG. 8 is a front perspective viewed from below and showing the door check device mounted on a door, with the action arm in door checking mode and engaging the reveal of a generally horizontal doorstop within a door jamb;

FIG. 9 is a perspective view similar to FIG. 8, showing the door stop on the face of a fully closed door, with the action arm pressed upwardly and ready for door checking when the door is reopened;

FIG. 10 is a perspective view similar to FIGS. 8 and 9, with the action arm in trigger re-set mode entering a door frame;

FIG. 11 is a perspective view similar to FIGS. 8-10, of a closed door with its door check device in a deactivated (disarmed) position so as to be essentially withdrawn from service.

FIG. 12 is a partial perspective view of the door check device base and shim illustrating an optional reversible interconnection to accommodate both left and right swinging doors.

### DETAILED DESCRIPTION OF THE INVENTION

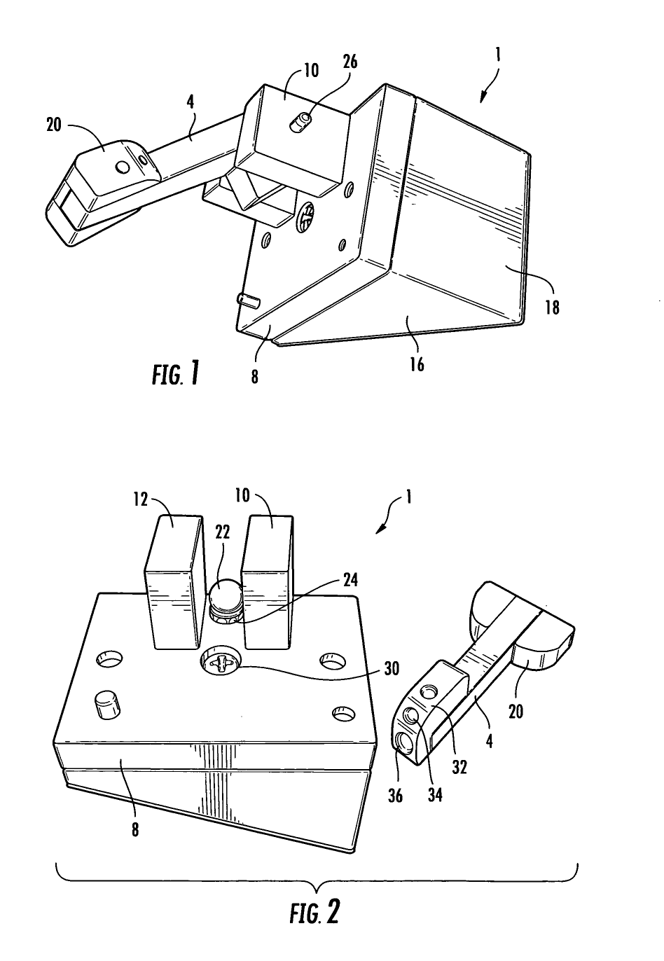

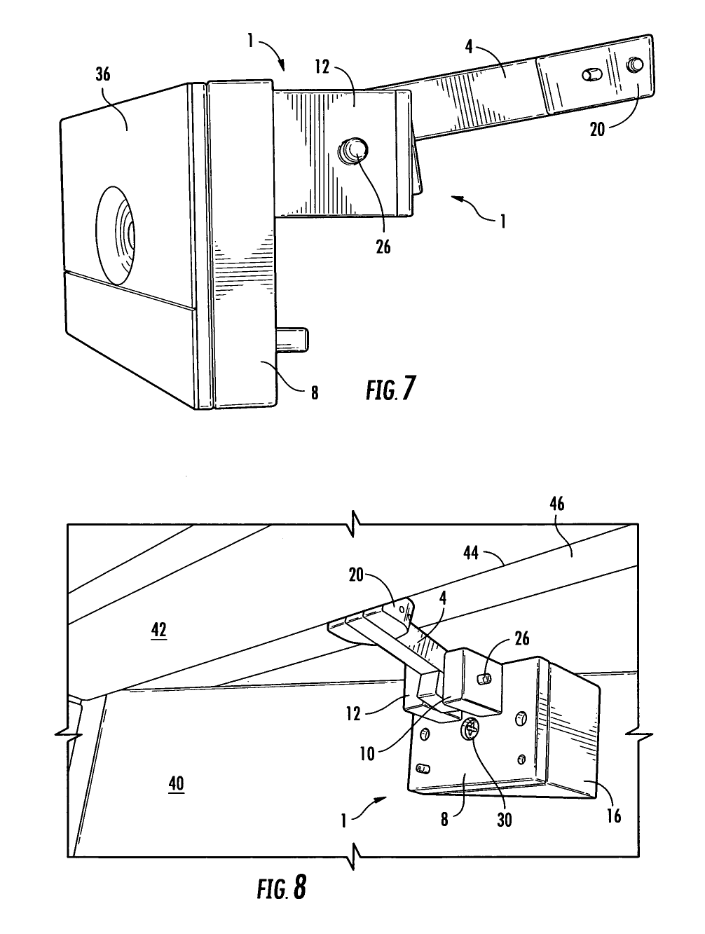

Looking more closely at the inventive door check device 1 depicted in FIGS. 1-12, it will be seen that the principal operative element is the outwardly projecting, articulated impact or action arm 4. This action arm 4 and its associated components may be fabricated from any of a variety of source materials. These materials include but are not limited to plastic, wood, metal, and the like, bearing in mind that to be qualified a source material must be sufficiently substantial to withstand repeated compressive and shearing impacts. Since this inventive device 1 is intended for widespread use, it also is important that the selected source materials be relatively inexpensive and easily manufactured and assembled.

The door check device 1 with impact or action arm 4 as viewed in FIGS. 1 and 2 extends from a proximal end at a base 8 to which it is mounted on pivot pin 26 in journal bearing block elements 10 and 12 (integral with, or affixed to, the base 8). The action arm extends outwardly to a terminus at its distal end 20. The action arm's distal end 20 is seen as having a working portion serving as a door check 1 as it impacts face 44 of doorstop 42 (see FIGS. 8-11). A suitably resilient impact pad or plate can be provided to avoid damage to doorstop 44 as is well known in the art.

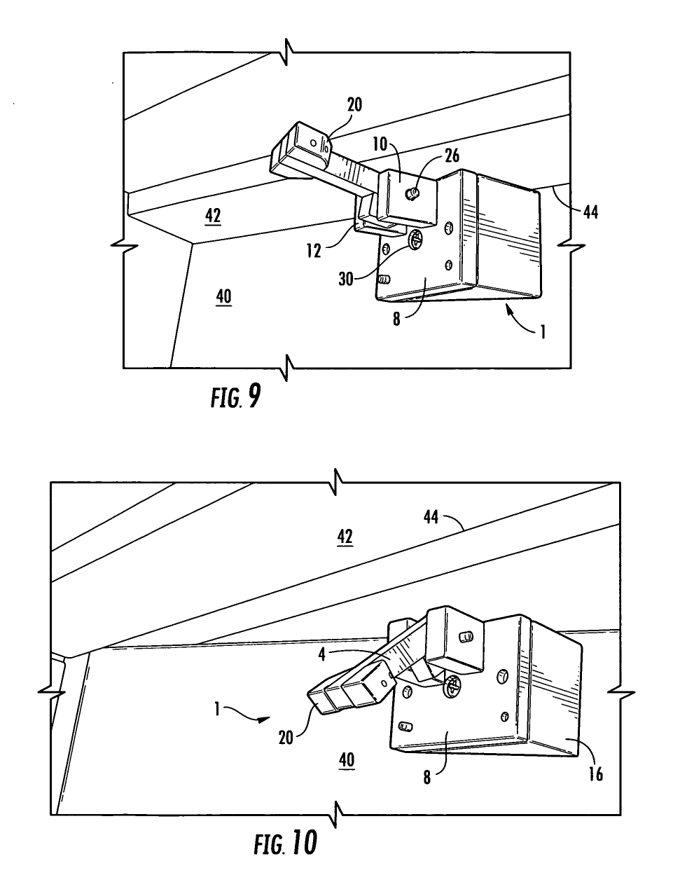

It should be clear that the action arm 4 may be a single, integral element or an assemblage as indicated in FIGS. 1 and 8, and may present any appropriate shape as long as it has sufficient reach to achieve a desired gap (also suggested in FIG. 8) when engaged against a face 44 (FIG. 10) of doorstop 42 (FIGS. 9-11). Advantageously, action arm 4 would include a broadened impact surface at its distal end 20 (see FIGS. 1, 3, 9, 10). The purpose of broadening the impact surface is to reduce the possibility that the arm will be snapped off or that the arm will cause impact puncture damage to the wooden frame reveal. Distal end 20 may, of course be a single flattened element that is either integral with, or attached to, the arm 4. Other shapes may be adequate as will be explained. A resilient tip (not shown) may be added to distal end 20 if so desired.

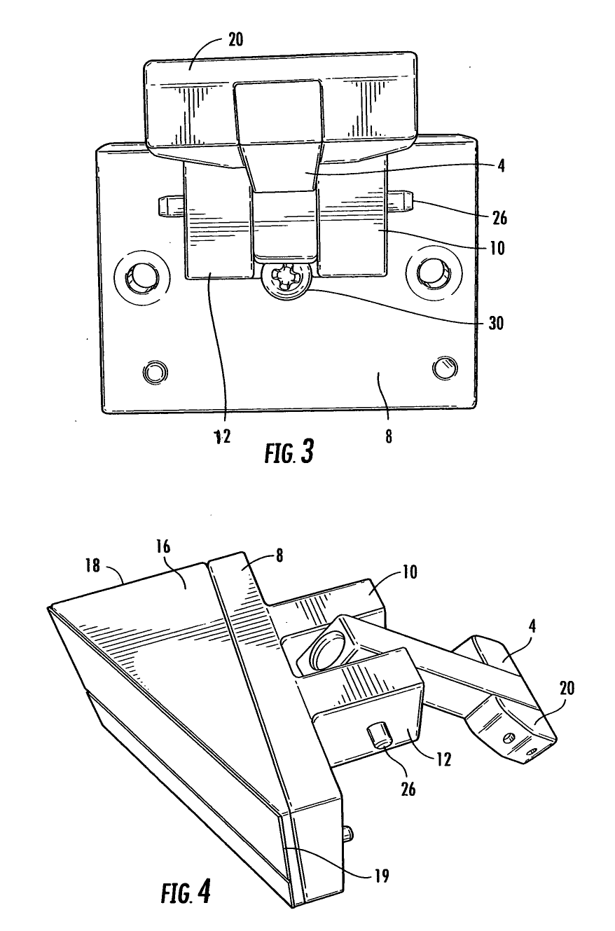

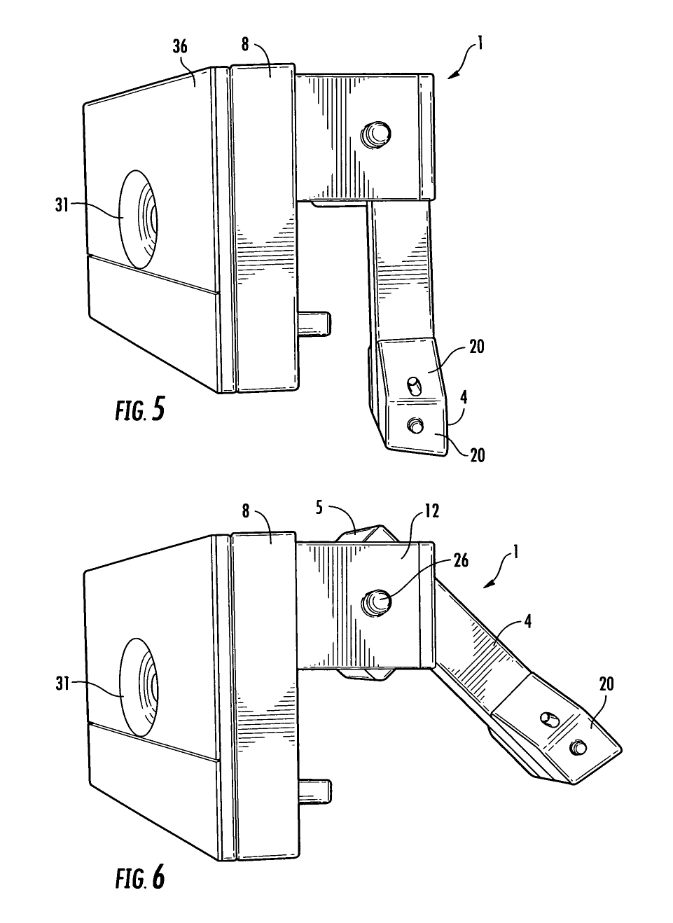

Device 1 base member 8, to which the articulated action arm 4 is pivotally journalled on pin 26, may be fastened to the door 40 (FIGS. 8-11) in any of a variety of ways. Base member 8 may be attached by bolt 30 to an intermediate wedge-shape shim element 16 (FIG. 9), though alternative wedge arrangements may be adequate, as well, as discussed below. Bolt 30 engages a matching nut (not shown) located in a rear face recess 31 in element 16 (FIGS. 5, 6). The purpose of the wedge shape shim element 16 is further discussed below. The assembly of the arm 4, base member 8 and shim 16 may be (for example only) attached to the door by means of high strength two-sided adhesive tape 19 (FIG. 4).

The assemblage just described as including base member 8, action arm 4, journal bearing block elements 10, 12 along with shim or wedge 16 could be attached by other equivalent means involving threaded or unthreaded fasteners, rivets, glue, tape and such. Moreover, the entire unit including elements 8, 4, 10, 12 and bore hole 24 (FIG. 2) for spring biased detent 22, could be injection molded or otherwise fabricated as a single integral unit. There is, however, an advantage to the use of a separate shim element 16 as will be noted below.

It is important that force vectors resulting from contact of the distal end 20 of articulated action arm 4 as it impacts the door stop 42 reveal surface 44 must be taken into consideration in device design. If the articulated arm 4 is mounted on a door surface 40 so as to be substantially perpendicular thereto, the dynamic angularity of door 40 movement toward the surface of doorstop reveal 44 will result in deflective shear of the articulated action arm 4. The intermediate wedge-shaped shim 16 serves to avoid breakage by initially positioning the articulated arm at a slight angle as now will be discussed.

Shim 16 is fastened between the safety device 1 base member 8 and the door 40 (FIGS. 4, 9, 10). The shim 16 is shaped so as to be thicker at one lateral edge 18 thereof (i.e., laterally, side-to-side of the door's closing surface). The shim 16 configuration results in the articulated arm 4 projecting outwardly from the door 40 at an obtuse angle (FIG. 9). As the door 40 and angularly extended action arm 4 move toward the doorstop, the angle of arm 4 will result its substantial normal (right angle) impact at reveal 44. This will avoid angular shear forces upon impact. As a consequence of the reduced likelihood of shear, the articulated arm 4 can be fabricated to have a less robust configuration.

The direction of door swing must also be taken into consideration. It will be advantageous to be able to mount the device at an opposite edge of door 40 when its swing is in a different direction (i.e., closes toward left rather than right). However, the angularity of the action arm 4 relative to the door stop 42 reveal surface 44 must also be reversed. Shim 16 thus is constructed as reversibly fastened by loosening bolt 30 and rotating the shim 16 a full 180-degrees (i.e., reversing placement of its thicker edge) to enable its use for either left-swing or right-swing doors.

Alternatively, shim 16 and base 8 can have a dovetail/groove interface thus avoiding all fasteners such as bolts, screws, friction clips and the like. For example, FIG. 12 shows a shim 16′ with a tongue 60′ feature configured to engage with an interference fit with corresponding groove 62′ in base 8′ (or, of course, vice versa). Shim 16′ could be withdrawn from its matching groove on base 8′ and turned 180-degrees for reversed engagement to base 8′. This reversal of shim 16′ will serve to change the slant or angular direction of the device 1 to conform to either door swing direction as discussed above. Other well known interference or snap-fit configurations may be applied, as well. To ensure stable operation, detents or motion stops may be included within such interference fit arrangements as is well known in the art.

For the inventive door check device 1 to work most effectively, it is important that the articulated action arm 4 assume different positions relative to the doorstop 44. The proximal end of the action arm 4 terminates in an arcuate portion (see FIG. 2) pivoted about axis pin 26 (FIG. 1) within journal structure 10, 12 on base 8. Defined in a surface of arcuate portion of action arm 4 are indexing sockets or depressions 32, 34, and 36 as viewed in FIG. 2. These defined indexing sockets or depressions 32, 34, 36 are collaboratively juxtaposed to a resilient detent ball 22 within spring bore 24 (FIG. 2). As the pivoted arcuate portion of arm 4 traverses the resilient detent ball 22, the nose of the latter will spring selectively into each of said defined indexing sockets 32, 34, 36. This collaboration between arm 4 and ball 22 serves temporarily to secure the action arm 4 in specific modes or positions.

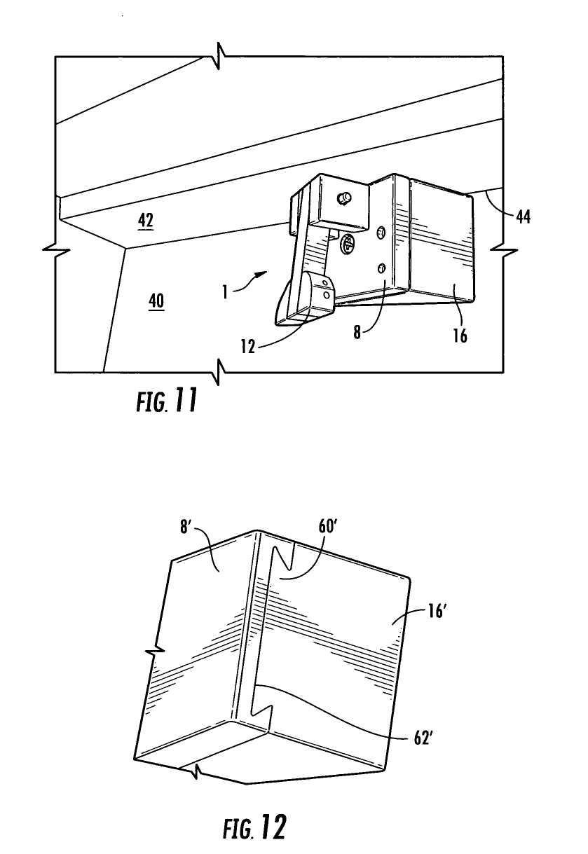

For example, when ball 22 is biased into defined indexing socket 36, arm 4 is set or indexed for door check mode as best shown in FIGS. 3, 7, 8. In this position, arm 4 approaches and directly engages doorstop 44. Similarly, when ball 22 is biased into defined socket 34, arm 4 is held in trigger re-set mode. In this latter mode, door 40 may be fully closed, but due to dosing interaction of the doorstop 42 with upwardly protruding corner 5 depicted in FIG. 6, the arm 4 will be raised slightly such that the nose of resilient ball 22 will slip into defined socket 36, readying device 1 for door checking mode when the door is reopened. Finally, defined socket 32 is associated with the action arm 4 deactivated mode (FIGS. 5, 11). Thus, to withdraw the door check device 1 from service, the nose of resilient ball 22 is set into defined socket 32 such that arm 4 is relatively vertical and there is no upwardly protruding corner 5 to cause further re-set (see FIGS. 5 and 11). Door 40 then operates in its normal state without interference from door check 1.

When use of the inventive door check device 1 is desired, a relatively tall person (e.g., an adult or older child) opens the door 40 and manually enables the articulated impact action arm 4 to its trigger re-set mode as depicted in FIGS. 1, 4, 6, 10. In this mode the action arm 4 pivots on pin 26 so as to project outwardly and slightly downwardly from its base 8.

As the door 40 then is dosed, the door check device 1 enters the door frame 42 where it glides beneath doorstop 44. But, as device 1 passes beneath doorstop 44, the uppermost corner 5 action arm 4 (see FIG. 6) engages against doorstop 44 with just enough interference to cause the action arm 4 distal end to be raised very slightly (FIG. 9). This in turn causes the detent or nose 22 to bias the action arm 4 proximal end toward the depression or socket 36 associated with the action arm 4 door checking mode. When the door 40 is subsequently opened, action arm automatically springs upward with the detent fully engaged into indexing socket 36. This ensures arm 4 is automatically raised to door checking mode. Subsequent attempts to close the door 40 with inventive device 1 in this mode will not be successful without adult intervention.

In summary, as a safety device this invention works by preventing a door from fully closing except by an adult or older child tall enough to disable the mechanism. The inventive door check device mounts on the door 40 closing face. The door check device action arm 4, when extended, stops the door 40 from fully closing by engaging door stop 44 wood trim, thus leaving a gap therebetween. Depending on the distance from the edge of the door where the device is mounted, the space or gap (see FIG. 8) between the door and the jamb (on the hinge side) can be regulated.

This door check device 1 not only helps prevent injuries from the hinge side of the door, but also the side that normally closes. It can be disabled by putting the arm 4 in its fully lowered position. For normal operations, the door 40 is opened and action arm 4 is placed in door checking position (indexed to extend slightly above horizontal). To dose the door 40 an adult or older child would need to flip arm 4 to a slanted position associated with its re-set mode. When the door 40 subsequently is re-opened, arm 4 springs up automatically and subsequently prevents the door 40 from closing fully, thus preventing injury.

Since the base 8 shim 16 can be reversed as explained, door check device 1 will accommodate left or right hinged doors (40). Tip 20 of arm 4, where it contacts the door stop is shown as widened to distribute the energy on impact so as to avoid damaging the door 40. Depending on materials employed, additional nailing or other fasteners may be necessary to ensure proper operation.

This invention boasts a number of novel features and advantages: prevents injury at all four edges of door 40; readily deploys by simply flipping arm 4; continuously operates in door check mode without constant re-set; does not include loose parts or items that can pose danger to infants or may be misplaced or lost; does not need to be removed from the door in order to cease its blocking action; use of the device does not impart permanent damage to the door (thus, it may be removed as children grow older); safeguards people of all ages from injury; may be fabricated at reasonable cost; simple to install and operate.

Although various embodiments of the present invention have been presented in the foregoing detailed description and accompanying drawings, it will be understood that the description is meant to be illustratively only and in no way limited to the embodiments disclosed. The present invention may assume numerous arrangements, rearrangements, modifications, and substitutions of steps without departing from the spirit of the invention or from the scope of the following claims.

I claim:

1. A closure check for selectively maintaining a predetermined gap between a closure and a closure stop within a closure frame, said closure check comprising:
a base configured for attachment to a closure surface, said base including a journal structure;
an elongated action arm pivotally mounted near its proximal end in said journal structure and extending outward therefrom to a distal end;
said action arm distal end configured for selective engagement against said closure stop;
said action arm including spaced position-determining indexing sockets defined along its proximal end;
a detent within said base journal biased against said action arm and arranged to selectively engage within said defined indexing sockets to set action arm positions;
a first of said indexing sockets defined on said arm collaborates with said biased detent to place said action arm in a closure checking position where said arm is pivoted upwardly relative to said base and configured to directly engage said closure stop within said closure frame;
a second of said indexing sockets collaborates with said biased detent such that said action arm is pivoted slightly downwardly relative to said base so as to assume a trigger re-set position and configured to move past said closure stop;
whereby positioning said detent and action arm in said closure checking position results in maintaining a predetermined gap between said closure and said closure stop, and alternatively positioning said detent and action arm in its lower trigger re-set position permits closure movement fully to closure stop without a gap.

2. The closure check of claim 1 further characterized by:
said action arm terminates at its proximal end with an arcuate portion where said sockets are defined, and terminates at a corner with an upward extent relative to said journal housing;
in said trigger re-set position with said arm pivoted slightly downwardly, said corner is configured to protrude beyond said journal housing;
said corner at its upward extent is configured to engage an edge of said closure stop as said check moves beneath said stop, causing the action arm to reverse its motion and re-set the detent into said first indexing socket;
whereby upon re-opening said closure, said action arm springs into closure checking position ensuring that subsequent dosing attempts will result in said predetermined gap being maintained.

3. The closure check of claim 1 further characterized by:
said closure check base is attached to a reversible intermediate wedge device configured for interconnection to a closure;
whereby said device and its action arm may be configured at a preselected angle relative to said closure stop such that action arm engagement therewith will be substantially normal, and said wedge may be optionally reversed so as to accommodate directionally different hinged closures.

4. The closure check of claim 3 wherein said check base is attached to said intermediate wedge device by removable attachment elements.

5. The closure check of claim 3 wherein said check base is attached to said wedge device by friction interfit elements.

6. The closure check of claim 1 further defined as including:
a third of said position-determining indexing sockets defined along said action arm proximal end and configured to collaborate with said biased detent such that said action arm is pivoted and set to a deactivated position substantially fully downwardly with respect to said base so as to move freely past said closure stop;
whereby said closure check may be withdrawn from service when not needed.

7. A door check for selectively maintaining a predetermined gap between a door closing face and a door stop within a door frame, said door check comprising:
a base configured for attachment to a door surface, said base including a journal structure;
an elongated action arm pivotally mounted near its proximal end in said journal structure and extending outward therefrom to a distal end;
said action arm distal end configured for selective engagement against said doorstop;
said action arm including spaced position-determining indexing sockets defined along its proximal end;
a detent within said base journal biased against said action arm and arranged to selectively engage within said defined indexing sockets to set action arm positions;
a first of said indexing sockets defined on said arm collaborates with said biased detent to place said action arm in a door checking position where said arm is pivoted upwardly relative to said base and configured to directly engage said doorstop within said door frame;
a second of said indexing sockets collaborates with said biased detent such that said action arm is pivoted slightly downwardly relative to said base so as to assume a trigger re-set position and configured to move past said doorstop;
whereby positioning said detent and action arm in said door checking position results in maintaining a predetermined gap between said door and said doorstop, and alternatively positioning said detent and action arm in its lower trigger re-set position permits door movement fully to doorstop without a gap.

8. The door check of claim 7 further characterized by:
said action arm terminates at its proximal end with an arcuate portion where said sockets are defined, and terminates at a corner with an upward extent relative to said journal housing;
in said trigger re-set position with said arm pivoted slightly downwardly, said corner is configured to protrude beyond said journal housing;
said corner at its upward extent is configured to engage an edge of said doorstop as said check moves beneath said doorstop, causing the action arm to reverse its motion and re-set the detent into said first indexing socket;
whereby upon re-opening said door, said action arm springs into door checking position ensuring that subsequent closing attempts will result in said predetermined gap being maintained.

9. The door check of claim 7 further characterized by:
said door check base is attached to a reversible intermediate wedge device configured for interconnection to a door;
whereby said device and its action arm may be configured at a preselected angle relative to said doorstop such that action arm engagement therewith will be substantially normal, and said wedge may be optionally reversed so as to accommodate directionally different hinged doors.

10. The door check of claim 9 wherein said check base is attached to said intermediate wedge device by removable attachment elements.

11. The door check of claim 9 wherein said check base is attached to said wedge device by friction interfit elements.

12. The door check of claim 7 further defined as including:
a third of said indexing sockets located to collaborate with said biased detent such that said action arm is pivoted and set to a deactivated position substantially fully downwardly with respect to said base so as to move freely past said doorstop;
whereby said check may be withdrawn from service when not needed.

13. A method of selectively maintaining a predetermined gap between a door's closing face and a doorstop within a door frame, said method including the steps of:
providing a door check device having a base configured for attachment to said door's closing surface and an elongated action arm;
further providing a pivot journal structure on said base including a resilient detent therein, and pivotally mounting said action arm at said journal structure such that said arm's distal end extends outwardly from said door and generally toward said doorstop;
further configuring said action arm proximal end to have an arcuate lower surface terminating at a corner with an upper extent relative to said journal structure;
providing indexing sockets in said arcuate lower surface positioned for selective collaboration with said resilient detent in association with each of at least two specific action arm positions;
configuring the first of said indexing sockets so as to be associated with said action arm's door checking position;
configuring the second of said indexing sockets so as to be associated with said action arm's trigger re-set position;
assembling said door check and mounting it on a closing surface of said door adjacent an upper edge thereof and opposite said door frame;
setting said door check device in trigger re-set position by engaging said resilient detent in said second indexing socket, slightly lowering said action arm while slightly raising said action arm proximate end upper corner relative to said journal structure;
closing said door toward said doorstop and directing said lowered action arm distal end to pass below said doorstop such that the upper extent of said corner engages said doorstop;
bringing said door to full closure, thus causing pressure on said action arm's proximal corner to pivot said action arm, resulting in said resilient detent slipping into the first of said indexing sockets and re-setting the action arm to its door checking position;
subsequently opening said door to trigger said action arm to its door checking position, ready for engagement with the doorstop when door closing is next attempted;
whereby said door check device maintains a predetermined gap between said door and said doorstop.
